(19) United States
(12) Patent Application Publication
(10) Pub. No.: US 2004/0157961 A1
(43) Pub. Date: Aug. 12, 2004

(54) Curable coating powders and powder coatings formed therefrom

(76) Inventors: Gordon Tullos, Reading, PA (US); Glenn Correll, Birdsboro, PA (US); Joseph Kozlowski, Reading, PA (US); Carryll Seelig, Reading, PA (US)

Correspondence Address: ROHM AND HAAS COMPANY, PATENT DEPARTMENT, 100 INDEPENDENCE MALL WEST, PHILADELPHIA, PA, 19106-2399, US

(21) Appl. No.: 10/764,614

(22) Filed: Jan. 26, 2004

Related U.S. Application Data
(60) Provisional application No. 60/443,778, filed on Jan. 30, 2003.

(51) Int. Cl. B05D 3/02; C08K 3/00

(52) U.S. Cl. 523/400; 427/372.2

(57) ABSTRACT

A coating powder formulation is made by blending compatible coating powder compostions, wherein the first coating powder compostions has an opacifier, a pigment, or a combination of opacifier and pigment that is different in type, amount, or both, from the second coating powder composition. The resulting contrast provides optical mouse activity to a powder coating formed from the blend.

### BACKGROUND

The present invention relates to coating powder compositions, methods for coating an article with such compositions, and coated articles formed thereby.

Coating powder compositions are dry, finely divided, free-flowing solid materials at room temperature. Upon application to a surface, they are heated to fuse and optionally cure, thereby forming a powder coating. Coating powders are conveniently applied using electrostatic methods, wherein an electric potential is generated between the coating powder and the substrate to be coated, causing the powder particles to be attracted to the substrate. Coating powders find particular utility in industrial coating applications because they are readily applied to a variety of conductive substrates, they use very little (or no) organic solvents, and excess coating powders can be readily recycled. They accordingly provide high coating efficiencies along with a reduction in the amount of waste generated in coating operations compared to other coating technologies.

Coating powders may also be used to coat heat sensitive substrates such as wood and plastic, which typically require low cure temperatures (i.e., below 120° C.) to avoid significant substrate degradation and/or deformation. For example, EP 916 709 A2 is directed to a one-component, low temperature curable coating powder that cures at 107 to 149° C., and produces a coating having an exceptionally smooth surface with either low gloss (i.e., a gloss level of less than 20 on a 60° Gardner Gloss scale), semi-gloss (i.e., gloss level of 20 to 70 on a 60° Gardner Gloss scale) or high gloss (i.e., more than 70 on a 60° Gardner Gloss scale). The ability to coat wood substrates is particularly useful for the manufacture of kitchen cabinetry, shelving and storage units, and home and business furniture, especially computer furniture.

One prevalent piece of computer hardware that interacts with the surface of computer and other furniture is an optical computer pointing device commonly referred to as an optical mouse. One advantage of the optical mouse is its ability to work on a variety of surfaces, without the need for a mouse pad or other type of surface compatible with the “roller ball” device of a mechanical mouse. Another advantage is its lack of moving parts that can become clogged with dust and debris, thereby leading to erratic cursor positioning behavior. In addition, developments in technology have obviated the need for optical mouse pads in which a X-Y grid of contrasting lines dispersed on a mouse pad were detected by an optical mouse.

In contrast to the traditional “roller ball” mouse, which uses a mechanical formulation to track the motion of the mouse through space, the optical mouse employs a light source, for example one or more light emitting diodes (LEDs) and a sensor or array of optical sensors to determine the relative motion of the device through space over time. In use, the light emitted from the source is reflected from a work surface, such as the top of a desk, back to the detector. The detector then sends a signal representative of the detected light to a signal processor wherein the signal is analyzed. However, specular reflection of light off of the work surface may result in a lack of information being detected by the optical sensors, thus rendering the optical mouse ineffective. In addition, overly diffuse reflection and/or absorption of the incident radiation may result in jitter of the cursor image, a delayed movement of the cursor, and/or a complete lack of movement of the cursor in an intended direction when the mouse is physically moved, thus rendering the optical pointer ineffective.

Wood and other surfaces having powder coatings applied thereto may lack effective optical mouse activity, particularly when the coatings have smooth surfaces and/or high gloss. It has been found that optical mouse activity is particularly poor for coatings that have a gloss of greater than or equal to 10 on a 60° Gardner Gloss scale. Accordingly, a need exits for coating powder compositions that cure to provide a powder coating having optical mouse activity at a wide variety of gloss levels and/or degrees of surface roughness. It would be a further advantage if such coatings could be provided in colors and at gloss levels that are identical, or at least very similar, to those already used by coaters. The inventors hereof have unexpectedly found that such coatings may be achieved by use of at least two coating powder compositions of contrasting color and/or opacity.

### STATEMENT OF THE INVENTION

In a first aspect of the present invention there is provided a coating powder formulation comprising a blend of a first coating powder and a second coating powder compatible with the first coating powder, wherein the first coating powder comprises an opacifier, a pigment, or a combination of an opacifier and a pigment that is different in type, amount, or both, from the second coating powder, the difference providing optical mouse activity to a powder coating formed from the blend. In a second aspect of the present invention there is provided a method of forming a powder coating on an article using the above-described formulation. In a third aspect of the present invention there is provided an article having a powder coating formed from the above-described formulation.

Use of contrasting opacifiers and/or pigments in the coating powders provides coatings that have effective optical mouse activity, particularly in coatings that have a gloss of greater than or equal to 10 on a 60° Gardner Gloss scale.

### DETAILED DESCRIPTION

For purposes of better defining the coating powder and powder coating, the coating powder composition, coating powder, or powder refers herein to the particulate material, and the powder coating or coating refers to the coating applied to a substrate or article. All parts and percentages specified herein are by weight unless otherwise stated.

A variety of coating powder compositions may be used in the present formulation. An example of a preferred type of coating powder is the “one-component” coating powders described in EP 916 709 A2, produced by grinding and screening an extrudate comprising an epoxy resin, a low temperature curing agent, a catalyst, and optional additives.

Preferably, the epoxy resins have melt viscosities from 300 to 3000 centipoise at 150° C., more preferably 300 to 2000 centipoise at 150° C. for smooth coatings, a T_{g} of 25° C. to 75° C., preferably 35° C. to 55° C., an equivalent weight of from 100 to 700, and may be used in the form of a mixture, for example an epoxy resin having an equivalent weight between 100 and 400 and one having an equivalent weight between 400 and 700, used in a weight ratio of from 1:99 to 99:1. Suitable epoxy resins include, for example, those produced by the reaction of epichlorohydrin and a bisphenol, e.g., bisphenol A and bisphenol F; and the epoxy resins known as EPN (epoxy phenol novolac) and ECN (epoxy cresol novolac) resins.

A crystalline epoxy resin may be added to the coating powder to improve the flow characteristics of the powders. A crystalline epoxy resin having a melting point of 80 to 150° C. is preferred, as is a crystalline epoxy resin having an equivalent weight of 185, such as, for example, the material available from Resolution Performance Products under the trademark RSS 1407. When present, crystalline epoxy resins are preferably used in amounts of 1 to 20% preferably 1 to 10% by weight of the total amount of the epoxy resin.

Suitable low temperature curing agents are active at 105 to 150° C. and include, for example, the epoxy adducts of aromatic polyamines or aliphatic polyamines (including cycloaliphatic polyamines) having a primary, secondary, or tertiary amino group or a combination of such amino groups. Such curing agents are sold, for example, under the trademarks HT 835 (Vantico Inc.), ANCAMINE 2337 XS, ANCAMINE 2014 AS, ANCAMINE 2441, and ANCAMINE 2442 (Air Products & Chemicals). It is preferred that the functionality of the adducting reaction mixture is 2 or less, and it is particularly preferred to use a difunctional epoxy compound. The amount of low temperature curing agent is preferably 2 to 40 parts by weight per hundred parts of the resin (phr).

The catalyst may be used at a level of 0.1 to 5 phr, preferably 0.2 to 2 phr to accelerate the curing reaction with the low temperature-curing agent. Suitable catalysts include, for example, tertiary amines such as triethylamine diamine; and imidazoles and epoxy adducts thereof, the imidazoles having the general formula:

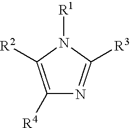

wherein R¹, R², R³, and R⁴ are independently hydrogen, alkyl, aryl, or a substituent that is not reactive with the epoxy resin. Suitable imidazoles include, for example, imidazole, 2-methylimidazole, and 2-phenylimidazole. Suitable exemplary adducts of these imidazoles with a bisphenol A epoxy resin are available commercially from Resolution Performance Products under its trademark EPON, e.g., EPON P-101, and also from Vantico, Inc., under the designation ARADUR 3261-US.

As stated above, other types of coating powder compositions are also suitable for use herein, for example, heat-curable coating powders comprising carboxylic acid-functional polyester resins and polyepoxy compounds such as triglycidylisocyanurate; heat-curable coating powders comprising linear carboxylic acid-functional polyester resins and glycidyl-functional (meth)acrylate copolymers; coating powders comprising hydroxy-functional polyesters and phenol- or caprolactam-blocked isocyanates; heat-curable coating powders comprising epoxy resins and curing agents such as phenol novolacs; and radiation-curable coating powders comprising ethylenically unsaturated resins such as unsaturated polyesters, unsaturated polyacrylate resins, unsaturated polymethacrylate resins, unsaturated urethane resins, unsaturated epoxy resins such as epoxy vinyl ethers, and combinations of the foregoing; and radiation-curable coating powders comprising. Such resins include, for example, unsaturated polyester resins, and the like. Coating powder compostions having dual-cure mechanisms, for example those comprising a combination of vinyl ether functionalized resins, epoxy-functionalized resins, and (meth)acrylate-functional resins are also useful.

Additives to aid or enhance the chemical and physical properties of the powder coating may be included in the powders, such as texturizing agents, flow control agents, gloss control agents, dry flow additives, anticratering or degassing agents, surfactants, light stabilizers, plasticizers, wetting agents, anti-oxidants, and the like.

Suitable texturing agents include, for example, organophilic clays, crosslinked rubber particles, and the like, or combinations comprising at least one of the foregoing texturing agents. Suitable gloss control agents, for example polyethylene waxes, oxidized polyethylenes, polyamides, polytetrafluoroethylenes, acid-functional acrylic resins, and the like may be used to adjust gloss. Suitable flow control agents include, for example, acrylic resins, silicone resins, and the like, or combinations comprising at least one of the foregoing flow control agents. One example of a suitable flow control agent is RESIFLOW® P-67, an acrylate flow modifier, from Estron, Calvert City, Ky. Suitable dry flow additives include, for example, fumed silica, alumina oxide, and the like, or combinations comprising at least one of the foregoing dry flow additives. Suitable anticratering agents include, for example, benzoin (2-hydroxy-1,2-diphenylethanone), low molecular weight phenoxy and phthalate plasticizers, and the like, or combinations comprising at least one of the foregoing anticratering agents. Suitable surfactants include, for example, acetylenic diol, and the like. Suitable light stabilizers include, for example, hindered amines, hindered phenols, or combinations comprising at least one of the foregoing light stabilizers. The amount of flow control agents, dry flow additives, anticratering agents, texturizing agents, surfactants, and/or light stabilizers can be readily determined by one of ordinary skill in the art, depending upon the desired physical properties of the resultant coating. In general, effective quantities of the foregoing are individually 1 to 15 phr.

Pigments and/or opacifiers are used in the coating powder compositions to provide color and opacity, respectively. Suitable pigments include, for example, carbon black, Shepard black No. 1, titanium dioxide white, chromium oxide green, zinc oxide, iron oxide yellows, reds, browns and blacks, such as ferrite yellow oxide, ferric oxides, raw sienna and burnt sienna, lead chromate, copper phthalonitrile blue, phthalocyanine blues and greens, ultramarine blue, toluidine red, parachlor red, cadmium reds and yellows, phthaloorganamine blues and greens, iron blues, and/or organic maroons. Others include anatase titanium dioxide, zinc sulfide, and the mixed metal oxide pigments, such as manganese ferrite black, chromium green black hematite, cobalt aluminate blue spinel, copper chromite black spinel, sodium alumina sulfosilicate, and metallics made with aluminum, mica, or brass.

Suitable fillers that may be used to adjust the opacity of the powder coating include, for example, silica, fumed silica, calcium carbonate, barium sulfate, mica, ammonium chloride, ammonium bromide, boric acid, antimony trioxide, fumed alumina, clays such as kaolin, china clay, talc, lithopone, zinc sulfide, lead titanate, zirconium oxide, white lead, barium oxide, calcium oxide or hydroxide, magnesium oxide or hydroxide, chalk, asbestos, ceramic, hollow glass, resin microspheres, pearl essence, barites, diatomaceous earth, aluminum trihydrate, onyx flour, calcium silicate, mixed silicates, and combinations comprising at least one of the foregoing.

It has been discovered that an optical mouse will function properly on cured powder coatings having a wide range of textures and gloss levels when the coating composition is formulated to provide an effective level of contrast in the powder coating. Effective levels of contrast can be imparted to the powder coatings by use of a powder formulation that comprises a blend of at least two compatible coating powder compositions, wherein one composition is formulated with pigments, opacifiers, or both, that are different in type, amount, or both, from the other formulation. Thus, one method to obtain a level of contrast in the powder coating that results in effective optical mouse function is to use a pigment in the first powder coating composition and no pigment in the second powder coating composition. The two coating powder compositions may then be blended to provide the formulation used in the powder coating process. Similarly, an opacifier may be used in the first powder coating composition, none in the second powder coating composition, and then the two compositions blended to provide the formulation used to coat the substrate.

Another method to obtain a level of contrast in the powder coating that results in proper optical mouse function is to use a first type of pigment in the first powder coating composition and a second type of pigment, preferably one that provides a contrasting color, in the second powder coating composition. Alternatively, a first type of an opacifier may be used in the first composition, and a second type in the second composition. Use of different particle size pigments and/or opacifiers in each coating powder composition may also aid in providing effective contrast.

The type of pigment and/or opacifier is determined primarily by the desired color and opacity of the powder coating. In general, the amount of pigment and/or opacifier used in each coating powder composition can vary widely, from a total amount of 0 to up to 120 phr, preferably 1 to 90 phr, more preferably 10 to 60 phr. Because the amounts of pigment and/or opacifier can be widely varied, the relative ratio of each coating powder composition in the final formulation can also be widely varied. However, in order to obtain even contrast, and thus good optical mouse function, it is preferred to mix the first and second coating powder compostions in weight ratios of 5:95 to 95:5, preferably 15:85 to 85:15.

The amount of contrast between the two (or more) coating compositions that is effective to provide improved optical mouse activity will vary depending on a number of factors, such as particle size, coating formulation, overall desired color of the coating, and the like. For example, an effective change in overall color (delta E, as measured using the CIELAB formulation) for white compositions may be greater than 2, greater than 3, greater than 5, or greater than 8. An effective delta E or red or orange compositions may be greater than 5, greater than 8, greater than 15, or for high chroma compositions, for example, greater than 25.

In a particularly advantageous feature of the present invention, it has been found that appropriate selection of types and/or amounts of pigments and/or opacifiers in the at least two coating powder compositions can provide powder coatings that appear essentially monochromatic to the eye, but that provide contrast on a small scale such that an optical mouse can function properly, and without significant jittering or skipping. In another advantageous feature, it has been found that appropriate selection of types and/or amounts of pigments and/or opacifiers in the at least two coating powder compositions can provide powder coatings that appear to have the same gloss, color and/or opacity as a given prior art coating, but that provides proper optical mouse functioning. This allows a manufacturer to use coatings that appear similar to previous coatings, but that now provide optical mouse activity. While acceptable differences between coating appearance varies depending on the particular application, an exemplary change in overall color (as reflected by delta E) is less preferably than 8, (particularly for high chroma oranges, for example), preferably less than 6, more preferably less than 4, and most preferably less than 2 (for whites, for example). The inventive coatings can thus be readily substituted for coatings in present use that do not provide proper optical mouse functioning.

In general, known methods may be used to form the coating powders. For example, one preferred method includes melt mixing, in which the dry ingredients are weighed into a batch mixer and are mixed with a medium intensity horizontal plowmixer or a lesser intensity tumble mixer. Mixing times may be from 1 to 3 minutes for the high intensity mixers, and from 30 to 60 minutes for the tumble mixers. The premix may then be further mixed and compounded as the resin is melted in either a single screw or a twin screw extruder for 0.5 to 1 minute. The extrudate may be cooled quickly and broken into small chips suitable for grinding. When “one component” compositions comprising epoxy resins having a T_{g} of 35° C. to 40° C. are used, sintering of the powder is avoided by allowing the temperature in the extruder to rise to activate the low temperature curing agent for a time sufficient to raise the extrudate viscosity beyond the sintering point, and then cooling the extrudate rapidly to 10 to 20° C. before chipping and grinding. The powder is also stored at such temperatures to avoid a further viscosity build-up by continued curing. Another way to avoid sintering of the powder when low T_{g} resins are used is to pre-mix the resin with a crystalline or non-crystalline curing agent powder having an average particle size of 5 micrometers or less that does not liquefy in the extruder. A specific example of a curing agent that may be so used in the powdered form is commercially available under the trademark ANCAMINE 2441 (Air Products & Chemicals).

The chips from the extruder are then ground to an appropriate particle size, generally 20 to 120 micrometers, preferably 30 to 80 micrometers, and screened. The at least two coating powder compostions may be ground and/or screened to different particle sizes, for example one composition screened at 60 mesh, and another screened at 140 mesh, to enhance contrast of the powder coating.

The at least two coating powder compositions are blending before or after grinding and/or screening to provide a coating powder formulation that may be used to coat glass, ceramics, and graphite-filled composites, as well as metallic substrates such as steel and aluminum. The formulation is particularly useful in the coating of heat sensitive substrates such as plastics, paper, cardboard, and woods. Wood is herein defined as any lignocellulosic material, whether it comes from trees or other plants, and whether it be in its natural forms, shaped in a saw mill, separated into sheets and made into plywood, or chipped and made into particleboard, or whether its fibers have been separated, felted, or compressed. Wood substrates are exemplified by lumber, panels, molding, siding, oriented strand board, hardboard, medium density fiberboard (MDF), and the like. Fiberboard having a pattern such as a simulated wood grain printed on its surface, rather than on a paper laminated to that surface, and a coating powder of this invention over said pattern has the appearance of natural wood. MDF is a particularly valuable coating substrate. Other heat sensitive substrates include plastics, such as acrylonitrile butadiene styrene polymer resins (ABS), polyphenylene ether resins (PPO), sheet molded compounds (SMC), polyolefins, polycarbonates, acrylics, nylons and other copolymers which usually will warp or outgas when coated and heated with traditional heat curable coating powders.

Substrates may preferably have a moisture content of 3 to 10% by weight of the substrate. In addition, the substrate may be treated to enhance its electrical conductivity. Optionally, these substrates may be filled or primed with ultraviolet radiation curable liquids, powder primers, or solvent or waterborne coatings to improve smoothness and reduce the required film buildups.

The coating powder formulation may be applied to substrates by conventional means, including electrostatic fluidized beds, electrostatic spray guns, triboelectric guns, and the like, in which the coating powder particles are electrostatically charged and the substrate is grounded or oppositely charged. The formulations are generally applied to achieve a coating thickness of 1.0 mil (0.0245 millimeters, “mm”) to 25 mils (0.635 mm), preferably at least 1.5 to 8 mils (0.038 to 0.204 mm).

Next, the powder coating layer is exposed to an amount of heat effective to fuse (i.e., melt) the powders into a continuous, smooth, molten film. The substrate may be heated at the time of application (pre-heated) and/or subsequently (post-heated) to effect heat fusion and film formation. Heating is performed in infrared, convection ovens, or a combination of both. When coating heat sensitive substrates, such as wood articles, pre-heat and post-heat steps are normally employed to enable faster melt and flow out. With plastic articles, only a post-heat step is usually performed to limit heat exposure and avoid plastic deformation.

Generally, heat fusion proceeds for a time effective to outgas substrate volatiles, which prevents surface defects such as blisters, craters, and pinholes from forming during curing. Preferably, the flow viscosity of the powder coating formulation is sufficiently low to produce a smooth coating on the substrate. In accordance with the present invention, coated powders are heat fused for 10 seconds to 10 minutes, preferably 20 seconds to 5 minutes, and most preferably 30 seconds to 3 minutes. Shorter heat fusion times are needed as the temperature of heat fusion is increased. In accordance with the present invention, coated powders are heat fused at 120 to 350° F. (49 to 177° C.), preferably 150 to 300° F. (65 to 149° C.), and most preferably 180 to 270° F. (82 to 132° C.). For example, powder coatings may be heat fused at 250° F. (121° C.) to 270° F. (132° C.) for 1 minute.

The applied powder layer may also be cured, generally at a temperature of 200 to 500° F. (93 to 260° C.), preferably 220 to 450° F. (104 to 232° C.), more preferably 250 to 400° F. (121 to 204° C.) for thermally cured coatings. Where low curing temperatures are desired, for example with wood substrates, cure is generally less than 325° F. (163° C.), more preferably less than 300° F. (149° C.), even more preferably less than 250° F. (121° C.). While the powder coatings are molten, radiation-cured coatings may be exposed to the appropriate radiation source.

Use of the above-described formulation results in powder coatings that provide effective optical mouse activity. In particular, specular reflection of light off of the work surface being detected by the optical sensors is improved and/or diffusivity of the reflection and/or absorption of the incident radiation is improved. This results in improved signal, reduced or eliminated jitter of the cursor image, and reduced or eliminated delay in cursor movement in response to mouse movement.

Specific embodiments of the invention will now be described in detail in the following Examples.

An Apple/Macintosh optical mouse was used to evaluate a coating powder formulation comprising a blend of a first, white coating powder composition and a second, clear coating powder composition. The first and second powder coating compositions alone were used as comparative examples. Formulations and testing results are shown in the Table. Amounts of the individual components making up each coating powder compositions are given as a percent by weight of each composition.

The White and Clear coating powders were prepared by initially blending by hand for 1 minute the components shown in the Table. The blend was then melt mixed in a 30 mm twin screw Baker Perkins extruder having a front zone maintained at 120° F. (°C.) and an unheated rear zone. The extrudate was then chipped and ground with 0.1-0.2% by weight of fumed alumina or fumed silica to a fine powder that passed through a 140 or 60 mesh screen (U.S. Standard) and indicated. The inventive formulation was obtained by mixing the White and Clear powders in the weight ratios indicated. All three powders were coated onto a substrate and cured by heating at 375° F. (190° C.) for five minutes.

Methyl ethyl ketone resistance (MEK resistance), a rating of solvent resistance and an indication of crosslink density, was measured as follows. A cotton swab was soaked in MEK and rubbed with pressure in a back and forth stroking motion 50 times. A relative rating was given on a scale of 1-5 with a rating of 5 defined as the most solvent resistant and a rating of 1 justified when the coating can be completely removed during the process to expose bare substrate. More specifically, a rating of 5 corresponds to no rub off, 4 to slight rub off, 3 to moderate rub off, 2 to severe rub off, and 1 to complete rub through to substrate.

Gloss was measured at 60° according to ASTM D523.

Gel time was measured according to a modified version of ASTM Specification D-3451.14 (modified). In the modified test method, a small quantity of powder (⅛ teaspoon) is dropped onto a hot plate at a given temperature, e.g. 149° C. (300° F.) and stroked with a tongue depressor until continuous and readily breakable filaments are formed when the depressor is lifted from the sample. The elapsed time for this to occur is measured in seconds and represents the gel time measurement.

In the hot plate melt flow (HPMF) test, a pellet of powder having a diameter of 12.7 mm and 6 mm thick is placed on a hot plate set at 300° F. (149+/−2° C.) at an inclination angle of 35°. The pellet melts and runs down the plate. The length of the flow is measured in millimeters. The distance the coating flows is dependent on the initial melt viscosity, the rate of reaction, the temperature at which the test is conducted, and the type and amount of catalyst.

| | White | | |
|---|---|---|---|
| | Coating | Clear Coating | Inventive |
| Component | Powder | Powder | Formulation |
| Amorphous epoxy resin | 60.80 | 70.37 | — |
| (Vantico) | | | |
| Crystalline epoxy resin | 3.20 | 3.70 | — |
| (Resolution Performance | | | |
| Products) | | | |
| Epoxy-amine adduct (Air | 5.76 | 6.67 | — |
| Products) | | | |
| 2-Phenylimidazole | 0.32 | 0.37 | — |
| Styrene-acrylic polymer | 8.96 | 13.34 | — |
| Flow control agent | 0.64 | 0.74 | — |
| Antioxidant | 0.32 | 0.37 | — |
| Glass beads (Potter Ind.) | 3.20 | 3.70 | — |
| Micronised wax | 0.64 | 0.74 | — |
| Nickel-antimony-titanium | 0.11 | — | — |
| yellow rutile pigment | | | |
| Iron oxide red pigment | 0.01 | — | — |
| Iron oxide black pigment | 0.04 | — | — |
| Titanium dioxide | 16.00 | — | — |
| White Coating Powder | — | — | 79 |
| Clear Coating Powder | — | — | 19 |
| Titanium dioxide coated mica | — | — | 2 |
| Properties | | | |
| Gel time at 300° F. (sec) | 182 | 157 | 129 |
| HPMF at 300° F. (mm) | 92 | 94 | 73 |
| Gardener 60° Gloss | 18 | 15 | 21 |
| MEK | 4 | 4 | 4 |
| Screen Size (mesh) | 140 | 60 | (Mixture) |
| Color DL* | Standard | N/A | −0.43 |
| Da* | Standard | N/A | −0.08 |
| Db* | Standard | N/A | 0.52 |
| DE | Standard | N/A | 0.68 |
| Optical mouse response | No | No | Yes |

In the above Table, DL* is the measured change in lightness/darkness, Da* is the measured change in red/green, Db* is the measured change in yellow/blue, and DE is the average overall color change. A negative sign in front of a value indicates the coating became darker or greener or bluer.

As the above data show, a smooth white powder coating was produced with significantly improved mouse response by making a smooth, contrasting blend comprising a white and a clear powder composition. A similar effect was not seen when a white and an off-white powder was blended.

In addition, the clear component in the above example was screened at a larger particle size than the white in order to increase contrast (visibility to the mouse). Some mica filler was also added to improve mouse response even further without significantly changing coating color and appearance of the coating.

What is claimed is:

1. A coating powder formulation comprising
a blend of a first coating powder and a second coating powder compatible with the first coating powder, wherein the first coating powder comprises an opacifier, a pigment, or a combination of opacifier and pigment that is different in type, amount, or both, from the second coating powder, the difference providing optical mouse activity to a powder coating formed from the blend.

2. The coating powder formulation of claim 1, wherein the coating powder compositions comprise an epoxy resin, a low temperature curing agent, and a catalyst.

3. The coating powder formulation of claim 1, wherein the epoxy resin has an equivalent weight of from 100 to 700, low temperature curing agent is an epoxy resin adduct of an aliphatic polyamine, and the catalyst is an imidazole having the general formula: 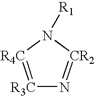
or an epoxy adduct thereof wherein R₁, R₂, R₃, and R₄ are independently hydrogen, alkyl, aryl or alkaryl.

4. The coating powder formulation of claim 1, wherein from 1 to 20 weight percent of the total weight of the epoxy resin is crystalline.

5. The coating powder formulation of claim 1, wherein the first coating powder composition has no pigment, and wherein the second coating powder composition comprises a pigment.

6. The coating powder formulation of claim 1, wherein the first coating powder composition comprises a first pigment having a first hue, and the second coating powder composition comprises a second pigment having a second hue different from the first hue.

7. The coating powder formulation of claim 1, wherein a delta E between the first and second powder coating compositions is greater than two.

8. A method of forming a coated article comprising
applying to a surface of a substrate the coating powder formulation of claim 1,
fusing the applied coating powder formulation; and
optionally curing the applied, fused coating powder.

9. The method of claim 8 wherein the substrate comprises wood.

10. A powder coating formed from the composition of claim 1.
